(19) United States
(12) Patent Application Publication
(10) Pub. No.: US 2008/0218035 A1
(43) Pub. Date: Sep. 11, 2008

(54) Rotating rectifier assembly

(75) Inventor: Majid Naghshineh, Wilmette, IL (US)

Correspondence Address: LAW OFFICES OF MICHAEL M. AHMADSHAHI, 600 ANTON BLVD., STE. 1100, COSTA MESA, CA, 92626, US

(73) Assignee: C.E. NIEHOFF & CO.

(21) Appl. No.: 11/716,510

(22) Filed: Mar. 9, 2007

(51) Int. Cl. H02K 11/04; H02K 11/00

(52) U.S. Cl. 310/68 D; 310/71

(57) ABSTRACT

A rotating rectifier assembly includes a metallic housing, a composite substrate, and a rectifier subassembly that can be used to rectify a polyphase AC current. The composite substrate includes a ceramic component and one or more metallic components according to a metallization process. The composite substrate and rectifier subassembly may be positioned in an annular cavity within the metallic housing. In applications where excessive heat and/or shock and vibration are present, an encapsulant may be used to fill the annular cavity.

### COPYRIGHT

A portion of the disclosure of this patent document contains material which is subject to copyright protection. The owner has no objection to the facsimile reproduction by anyone of the patent disclosure, as it appears in the Patent and Trademark Office files or records, but otherwise reserves all copyright rights whatsoever.

### FIELD OF INVENTION

This invention is related to a rotating rectifier assembly that may be used in combination with generators and/or electrical motors. In particular, the present invention relates to a rotating rectifier assembly that uses a composite substrate which renders the assembly electrically insulated from internal and/or external components while allowing it to efficiently transfer heat to the environment. Alternatively, the rotating rectifier of the present invention may utilize an encapsulant where excessive heat and/or shock and vibration are present.

### BACKGROUND

The present invention relates to a rotating rectifier assembly that may be used in a generator, such as a high power density generator, wherein the assembly provides a direct current (DC) to a field generating unit, such as a field generating rotor, of the generator. The rotating rectifier assembly of the present invention comprises a metallic housing with an annular cavity where a composite substrate is positioned. The composite substrate is made up of a ceramic part and a metallic part, wherein the latter is fused onto the former via a ceramic metallization process. The composite substrate is further used to couple a rectifier subassembly, wherein one or more rectifying diodes and associated rectifier circuit may produce a half-wave or full-wave rectified electrical current from an alternating current (AC). The composite substrate may further be used as a means to electrically isolate the rectifying diodes from one another and/or the rotating rectifier assembly from external components such as the generator. The rotating rectifier assembly may operate in a generator with an air-cooled system. An encapsulant may be used to fill the annular cavity so as to provide an efficient means to transfer the heat generated within the assembly to the environment while increasing its mechanical strength. Due to its mechanical strength, the rotating rectifier assembly of the present invention is well suited for generators that operate at high rotational speeds while being subjected to excessive shock and vibration.

Generators used in electrical systems such as those found in modern vehicles, including automobiles, trains, ships, aircrafts, and spacecrafts are expected to produce high output power while becoming smaller in size. Such generators can meet these demands by incorporating a rotating rectifier assembly. A generator of this type is well known in the art. An exciter unit is used to provide DC current to the generator's main rotor windings, wherein the latter induces an AC current in the generator's main stator windings via the former's rotating magnetic field. The exciter unit comprises an exciter rotor with windings that rotate with the generator shaft/rotor. The exciter rotor windings produce an AC current that is a result of a DC current through an associated exciter stator windings. In some generators, the exciter stator windings receive DC current from a permanent magnet generator within the main generator, and in some others, the DC current is supplied through an external source such as one or more batteries in the vehicle electrical system.

The exciter rotor generates an AC current via one or more phase windings. In a typical exciter rotor winding, a three-phase AC current is generated which is rectified by an associated rotating rectifier assembly, such as the rotating rectifier assembly of the present invention. Several designs have been utilized. In one instance, the rotating rectifier assembly is an integral part of the exciter rotor wherein a rectifying circuit, including one or more rectifier diodes, is attached to the exciter rotor. In another instance, the rotating rectifier assembly is a separate unit that is attached to the exciter rotor. The advantages of the latter design are that it's modular and more efficient in heat transfer. Modularity provides ease of assembly and reduced replacement cost. Efficiency in heat transfer stems from the fact that the heat generated from the rectifying devices, such as rectifying diodes, can be transferred to a cooler medium, such as the housing of the rotating rectifier assembly. In an integrated exciter unit, the rectifying devices are in direct contact with the exciter rotor whose temperature is elevated due to the heat generated by the current in the phase windings.

Heat generated by the rectifying devices in the exciter unit directly affects the output of the main generator. High operating temperature limits the power the rectifying devices can safely handle. The power from the rectifying devices is the power for the main field that produces the generator's output power. As the power output of the generator is directly proportional to the magnetic field, any reduction in the exciter current reduces the generator's output power. Consequently, an improvement in heat transfer from the rectifying devices increases the output power of the generator without an increase in its physical size.

Some or all of the rectifying devices, even in a half-wave rectification circuit, must be isolated from the ground. Where full-wave rectification is desired and the zero potential reference is other than the body of the generator, commonly referred to as an isolated ground generator, all the rectifying devices must be electrically isolated from the body of the generator. Such electrical isolation hinders the transfer of heat generated by the rectifying devices. In an isolated ground generator design the amount of heat, generated by the rectifying devices, that must be dissipated to the environment without direct heat conduction to the body of the rotating rectifier assembly is twice the amount for a grounded generator.

Heat transfer from the rectifying devices is more challenging in an air-cooled generator. In a generator where fluid, such as oil, is used to cool the internal components of the generator, heat generated by the rectifying devices is transferred to the fluid via conductive and convective heat transfer. In an air-cooled generator, heavy emphasis is on efficient heat transfer to the body of the generator through heat conduction, and from the body to the moving air through heat convection. Thus, an improvement in conductive heat transfer from the rectifying devices to the environment, including to the body of the generator, directly increases the output power of the generator as discussed above.

The generator's performance is directly affected by the mechanical integrity of the rotating rectifier assembly. Shock and vibration imparted by the vehicle on the generator requires a rugged rotating rectifier assembly. Exposure to sudden forces and moments result in high stresses that cause cracks and eventual fracture of the assembly. Vibration causes cyclic loading that leads to fatigue. Furthermore, fastened components, such as the rectifying devices, exposed to vibration tend to unfasten prematurely or lose close contact with their mating parts. The former leads to total failure of the rotating rectifier assembly while the latter causes excess heat.

Consequently, there is a need for a rotating rectifier assembly that 1) is small in size, 2) can produce high DC current, 3) dissipate its heat, and 4) withstand large shocks and vibrations. Although various systems have been proposed which touch upon some aspects of the above problems, they do not provide solutions to the existing limitations in providing a rotating rectifier assembly that may be used in high power density generators.

For example, the Doherty et al. patent, U.S. Pat. No. 6,903,470, discloses a high-power rotating rectifier assembly and its cooling system for a high speed generator. The rotating rectifier assembly comprises a hub with an inner and an outer circumferential surface that include at least one pair of flow passages and at least one flow channel. The pair of flow passages and flow channel allow a cooling medium, such as oil, to flow directly across the hub of the rotating rectifier assembly and cool the rectifier diodes mounted within the cavity formed in the hub. However, the rotating rectifier assembly can not operate in an air-cooled generator as it requires a fluid medium to dissipate the heat generated by the rectifier diodes.

In Johnsen, U.S. Pat. No. 5,587,616, a compact rotating rectifier assembly of a unitary construction is disclosed. The rotating rectifier assembly includes field plates, layers of phase plates, layers of diode devices, and means for integrally joining these components to form a unitary, laminated structure rotatable about an axis of rotation. In one embodiment, a metallized ceramic plate is used to provide radial support to the assembly. The rotating rectifier assembly of the present invention is structurally different in that it does not use multiple layers of phase plates. Furthermore, the metallized ceramic plate used in the present invention is in contact with a housing that is at a lower temperature compared to the ceramic plate whereas in Johnsen, the ceramic plate is positioned between two field plates that are at approximately the same temperature. Additionally, the rotating rectifier assembly of the present invention may use an encapsulant that provides a cooling medium whereas the Johnsen's rotating rectifier assembly dissipates heat into ambient air or cooling fluid.

Shahamat et al., U.S. Pat. No. 5,166,564, discloses a rectifier assembly that is similar in construction to that described in Johnsen's. Shahamat's rectifier assembly comprises two output plates, axially separated by an insulating spacer, and a plurality of first and second diode wafers are brazed onto each output plate. The output plates provide a means to connect a pair of output terminals through which a rectified DC current is provided, and to dissipate heat generated by the diode wafers. The present rotating rectifier assembly is different in construction in that it does not use output plates. Furthermore, the rectifier assembly of the present invention uses a composite substrate that provides electrical insulation while transferring heat generated by rectifying diodes.

Tumpey et al., U.S. Pat. No. 5,013,949, discloses a high power rotating rectifier assembly that uses a composite substrate which has a metal core and a ceramic coating. Furthermore, the Tumpey's rotating rectifier assembly uses a fluid coolant as a means to dissipate heat generated by the rectifying diodes. In contrast, the rotating rectifier assembly of the present invention uses a composite substrate that has a ceramic core and a metal portion that is bonded to the ceramic core via a metallization process. Additionally, the rotating rectifier assembly of the present invention may use an encapsulant to dissipate heat rendering it operational in air-cooled machines.

Modern dynamoelectric machines, such as a high power density generator used in vehicle electrical systems, require rotating rectifier assemblies that are compact, light weight, efficient in heat transfer, and mechanically strong. These characteristics counteract in that reduced size and weight limit mechanical strength and efficient transfer of heat. An optimal balance can be achieved by providing for a metallic housing comprising an annular cavity, a composite substrate including a rectifier subassembly disposed therein, and an encapsulant that fills the cavity. The rotating rectifier assembly of the present invention meets these requirements while providing a high DC current demanded by high power density generators.

### SUMMARY

The present invention discloses a rotating rectifier assembly which may be used in a high power density generator. It rectifies a polyphase AC current and outputs a DC current that may feed the generator's main rotor windings. The rotating rectifier assembly includes a metallic housing that comprises an annular region wherein a composite substrate is positioned. A rectifier subassembly is coupled with the composite substrate wherein the input AC current selectively may be half-wave or full-wave rectified, and wherein the output DC current selectively may be a negative or isolated ground. An encapsulant substantially may be used to fill the cavity formed within the housing annular region to facilitate an efficient cooling medium and mechanical strength.

In one aspect, a rotating rectifier assembly is disclosed comprising a metallic housing including an annular cavity, a composite substrate disposed within the cavity, and a rectifier subassembly coupled with the composite substrate. Depending on the application, an encapsulant may be used to fill the cavity providing improved heat transfer and mechanical strength. Preferably, the housing comprises a bore through which it may be fitted onto a rotor according to a fastening fit such as interference and shrink fits. Alternatively, the housing may be fastened to the rotor through one or more holes operative to receive one or more fasteners. Preferably, the fasteners comprise an electrically insulating material.

In another aspect, a rotating rectifier assembly is disclosed comprising a metallic housing including an annular cavity, a composite substrate disposed within the cavity, and a rectifier subassembly coupled with the composite substrate. Depending on the application, an encapsulant may be used to fill the cavity providing improved heat transfer and mechanical strength. Preferably, the composite substrate is coupled to the metallic housing via an adhesive. Preferably, the composite substrate comprises a ceramic and a metallic component wherein the metallic component is fused onto the ceramic component through a metallization process. Preferably, the composite substrate comprises two separate metallic regions that may be used in an isolated ground configuration. Alternatively, a substantially half circle composite substrate may be used in a negative ground implementation.

In another aspect, a rotating rectifier assembly is disclosed comprising a metallic housing including an annular cavity, a composite substrate disposed within the cavity, and a rectifier subassembly coupled with the composite substrate. Depending on the application, an encapsulant may be used to fill the cavity providing improved heat transfer and mechanical strength. Preferably, the rectifier subassembly comprises one or more rectifying diodes that may be of standard and/or reversed polarity. Preferably, the rectifier subassembly comprises one or more printed circuit boards and output terminals. Preferably, the composite substrate and the rectifier subassembly are encapsulated by an epoxy.

### BRIEF DESCRIPTION OF THE DRAWINGS

FIG. 1 shows a perspective view of a rotating rectifier assembly coupled with a rotor according to a preferred embodiment.

FIG. 2 shows a perspective view of a metallic housing included in the rotating rectifier assembly shown in FIG. 1 according to a preferred embodiment.

FIG. 3 shows a perspective view of a composite substrate included in the rotating rectifier assembly shown in FIG. 1 according to a preferred embodiment.

FIG. 4 shows an exploded view of the composite substrate shown in FIG. 3, together with electrical components included in a rectifier subassembly of the rotating rectifier assembly shown in FIG. 1 according to a preferred embodiment.

FIG. 5 shows an exploded view of the metallic housing shown in FIG. 2, together with the composite substrate and rectifier subassembly shown in FIG. 4 according to a preferred embodiment.

### DETAILED DESCRIPTION OF THE PRESENTLY PREFERRED EMBODIMENTS

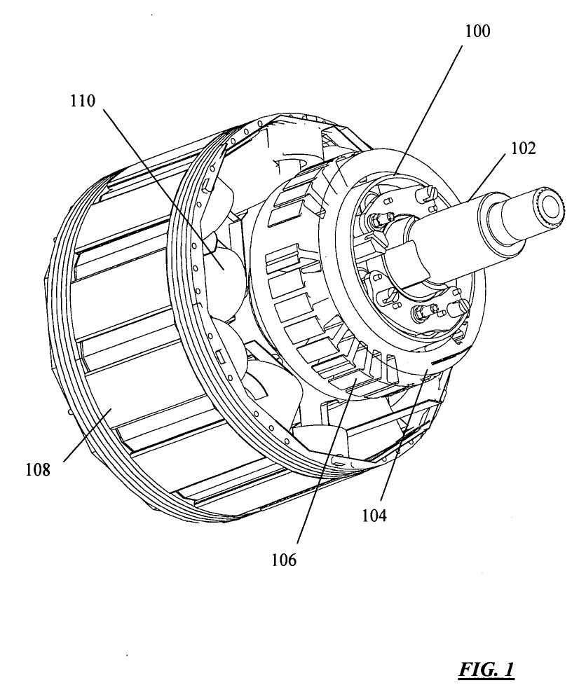

FIG. 1 depicts a perspective view of a preferred embodiment of a rotating rectifier assembly 100 coupled with a shaft 102 and an exciter rotor 104 of a generator (not shown). A plurality of exciter rotor poles 106 of the exciter rotor 104 interact with a plurality of exciter stator poles (not shown) to produce a polyphase AC current. The interaction is a result of a DC current through a plurality of exciter stator windings (not shown), which induce the polyphase AC current in the windings (not shown) of the exciter rotor 104 upon rotation. The rotating rectifier assembly 100 operates to rectify the polyphase AC current for consumption by the rotor windings 110 of the generator main rotor 108. The rotor windings 110, in turn, induce a polyphase AC current in the generator main stator windings (not shown) which may be further rectified to provide a DC current to a battery and/or a load such as lights in a vehicle electrical system.

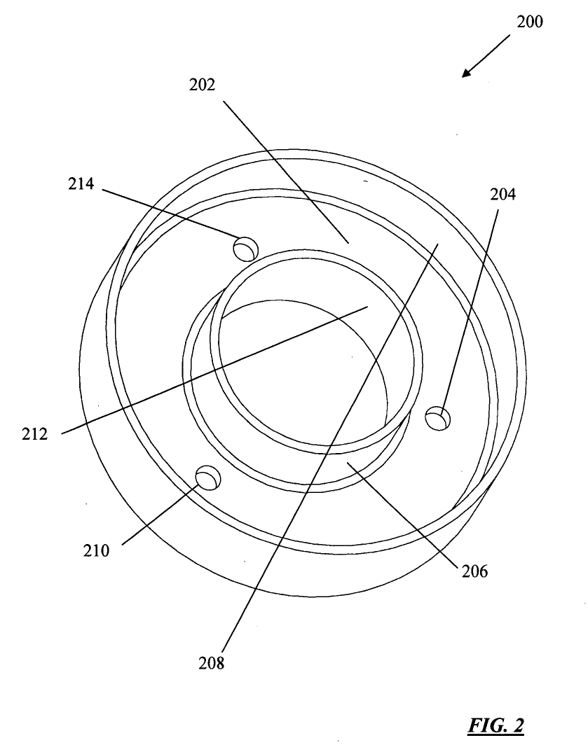

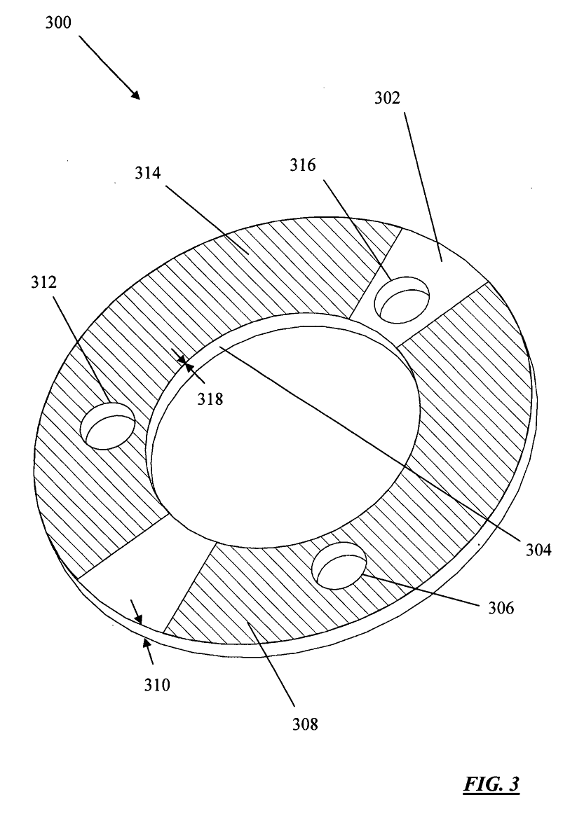

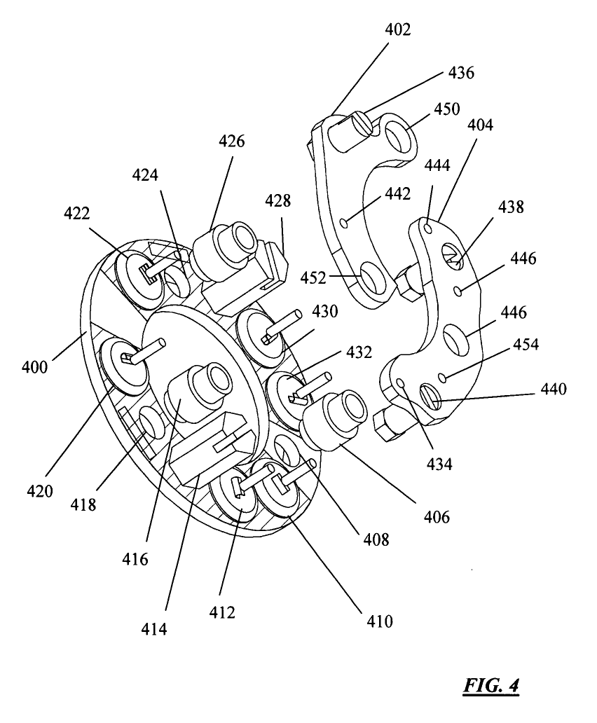

FIG. 2 depicts a perspective view of a preferred embodiment of a metallic housing 200 of a rotating rectifier assembly such as the rotating rectifier assembly 100 shown in FIG. 1. The metallic housing 200 is substantially circular in shape and comprises an annular cavity 202 defined as the space between an inner surface 208 and an outer surface 206. The metallic housing 200 further comprises one or more holes, 204, 210, and 214, which may be utilized to receive one or more fasteners (see FIG. 4) to secure a composite substrate (see FIG. 3) and couple the rotating rectifier assembly 100 to an exciter rotor such as the exciter rotor 104. The metallic housing 200 may further comprise a bore defined by a circular surface 212 which may be used to receive a shaft, such as the shaft 102, via a fastening fit such as a press fit or an interference fit.

The metallic housing 200 is used to position and secure a composite substrate (FIG. 3, discussed below) and a rectifier subassembly (FIG. 4, discussed below), in addition to provide an annular cavity for an encapsulant such as an epoxy to fill the cavity. The material used may be any metallic material such as aluminum, steel, and their alloys. A preferred material is aluminum because of its heat-transfer superiority, its relative low cost, and ease of machining. As will be more fully discussed below, the metallic housing 200 is used to provide a medium for the heat that is generated by the electronic components within the rectifier subassembly (FIG. 4, discussed below) to dissipate. The electronic components include a plurality of rectifying diodes which generate heat during switching operation.

In an alternative embodiment, the metallic housing 200 may be an integral part of a one-piece exciter rotor whereby an annular cavity, such as the annular cavity 202, is machined from the one-piece exciter rotor. However, providing a separate metallic housing, such as the metallic housing 200, allows a more efficient heat transfer. This is because in a one-piece exciter rotor, the composite substrate and rectifier subassembly are in direct contact with the exciter rotor poles of the one-piece exciter rotor which are at elevated temperatures due to heat generated by the rotor windings. Another advantage of a separate metallic housing is that it makes repair and replacement of the exciter rotor assembly less expensive. In a one-piece configuration, the complete exciter rotor assembly including the exciter rotor must be replaced when there is a malfunction within the assembly. Providing a separate metallic housing, separates the input side of the exciter rotor assembly, namely the exciter rotor including the windings from its output side, namely the composite substrate and electronic components within the rectifier subassembly.

The composite substrate and rectifier subassembly are positioned within the cavity 202 of the metallic housing 200 and, depending on the application, an encapsulant such as epoxy may be used to substantially fill the cavity 202. The holes 204, 210, and 214 are provided to receive one or more fasteners (see FIG. 4) to secure the composite substrate and rectifier subassembly to the metallic housing 200 and exciter rotor 104. The inner surface 208 and outer surface 206 secure the composite substrate within the annular cavity 202 and prevent radial deflection of the composite substrate at high rotational speeds. Excessive deflections of the composite substrate and/or rectifier subassembly may cause fracture, disconnection, and other types of malfunction. The inner surface 208 and outer surface 206 also provide surface areas for the encapsulant to bond with and dissipate heat into. As will be more fully discussed below, the encapsulant further provides cushioning for the composite substrate and electronic components in the rectifier subassembly. Such cushioning is desirable in applications where excessive shock and vibration are present.

FIG. 3 depicts a perspective view of a preferred embodiment of a composite substrate 300 of a rotating rectifier assembly such as the rotating rectifier assembly 100 shown in FIG. 1. In one preferred embodiment wherein isolated ground configuration is desired, the composite substrate 300 is a complete circle as shown in FIG. 3. In a negative ground configuration, the composite substrate 300 may be made substantially circular of differing arc angles depending on the size of the electronic components that are positioned on the composite substrate 300 (see FIG. 4, discussed below). The composite substrate 300 comprises a ceramic region 302 and two metallic regions 308 and 314. The holes 306, 312, and 316 are provided to receive one or more fasteners (see FIG. 4) to secure the composite substrate to the metallic housing 200. In the isolated ground configuration, the fasteners are electrically insulating material. The composite substrate 300 may further comprise a bore defined by a circular surface 304 which may be used to receive a hub such as that defined by the outer surface 206 of the metallic housing 200.

The composite substrate 300 is made of a ceramic component 302 and one or more metallic component 308 and 314 through a metallization process. The ceramic component 302 is of a thickness 310 and provides structural support for the components of the rectifier subassembly (see FIG. 4, discussed below). The thickness 310 may vary according to the application. Thicker substrates provide better structural support but transfer heat less efficiently. The ceramic component 302 further provides electrical insulation while facilitating a medium through which heat, generated by the rectifier subassembly, can be dissipated into the surrounding media such as the metallic housing 200 and/or encapsulant. In a preferred embodiment, the ceramic component 302 is an AD-96 Alumina available from CoorsTek of Golden, Colo.

The metallic components 308 and 314 may comprise nickel, tin, copper, gold, or any other metal, known to skilled artisans, suitable for the metallization process. The metallic components 308 and 314 are electrically conductive and provide electrical return paths for the rectifying diodes. A thickness 318 of each of the metallic components 308 or 314 may vary according to the application. The more electrical current passes through the metallic components 308 and 314, the thicker the thickness 318 should be to efficiently dissipate the heat generated within the metallic components 308 and 314. Although thicker metallic components transfer heat more efficiently, they may induce or accelerate fatigue failure at the interface with the ceramic components 308 and 314.

According to one embodiment, a full wave rectifying circuit utilizes two or more rectifying diodes which are positioned on the metallic components 308 and 314. In particular, one or more standard polarity diodes (see FIG. 4) are placed on the metallic component 308, and one or more reverse polarity diodes (see FIG. 4) are placed on the metallic component 314. For instance, for a three phase AC current, three standard polarity diodes are positioned on the metallic component 308, and three reverse polarity diodes are positioned on the metallic component 314, thereby providing a DC current to a generator main rotor, such as the generator main rotor 108 shown in FIG. 1.

The metallic components 308 and 314 are also used to provide a surface area to attach two output terminals (see FIG. 4). The anode and cathode sides of the respective standard and reverse polarity diodes are connected to the corresponding metallic components 308 and 314, thereby providing a DC current across the output terminals. The output terminals, in turn, may be connected to phase windings of a generator main rotor, such as the generator main rotor 108 shown in FIG. 1.

As mentioned above, in a negative ground configuration, the composite substrate 300 may be made substantially circular in shape of differing arc angles. In one embodiment, the composite substrate 300 may be a half circle comprising a half circle ceramic component and a half circle metallic component. One set of diodes, say standard polarity diodes and one output terminal, are connected to the metallic housing 200. The other set of diodes and a corresponding output terminal are connected to the half circle metallic component of the half circle composite substrate.

The composite substrate 300 is coupled with the metallic housing 200 via an adhesive (not shown) in addition to the aforementioned fasteners. The adhesive provides adhesion and intimate contact with the metallic housing 200 to facilitate better heat transfer known to skilled artisans. Microscopic air gaps between the composite substrate 300 and metallic housing 200, created by their respective surface roughness, are replaced by the adhesive. Since the adhesive has a considerably higher thermal conductivity than air, heat generated by the electrical components within the rectifier subassembly is transferred to the metallic housing 200 more efficiently.

FIG. 4 depicts an exploded view of a preferred embodiment of a composite substrate 400, together with the electrical components included in the rectifier subassembly. According to this preferred embodiment, the rectifier subassembly performs full wave rectification on a three-phase AC current and provides an isolated-ground DC current. For instance, the three-phase AC current generated by the exciter rotor 104 can be full-wave rectified to produce a DC current for consumption by the generator main rotor 108 shown in FIG. 1.

The electrical components comprise three standard polarity diodes 410, 412, and 420, three reverse polarity diodes 422, 430, and 432, three electrically insulating fasteners 406, 416, and 426 operative to fasten the composite substrate 400 to a metallic housing such as that shown in FIG. 2 via three holes 408, 418, and 424. The electrical components further comprise three input terminals 436, 438, and 440 where the three phases of the windings (not shown) of an exciter rotor such as the exciter rotor 104 shown in FIG. 1 are connected and two output terminals 414 and 428 through which a full-wave rectified DC current is provided. The electrical components further comprise one or more PC board to complete the electrical circuit.

According to one embodiment, two PC boards 402 and 404 are used to receive the three input terminals 436, 438, and 440 and three electrically insulating fasteners 406, 416, and 426 via three holes 450, 446, and 452. The two PC boards 402 and 404 further receive the three standard polarity diodes 410, 412, and 420 and the three reverse polarity diodes 422, 430, and 432 via holes 434, 442, 444, 446, 454, and a six hole that is not shown in FIG. 4 due to the angle of view. The two PC boards 402 and 404 comprise multiple layers of embedded electrical paths, known to skilled artisans, to complete the electrical circuit between the three-phase connections and rectifier diodes. Electrical connections between the composite substrate 400, the aforementioned electrical components, and PC boards 402 and 404 are made by brazing and/or high temperature soldering known to skilled artisans.

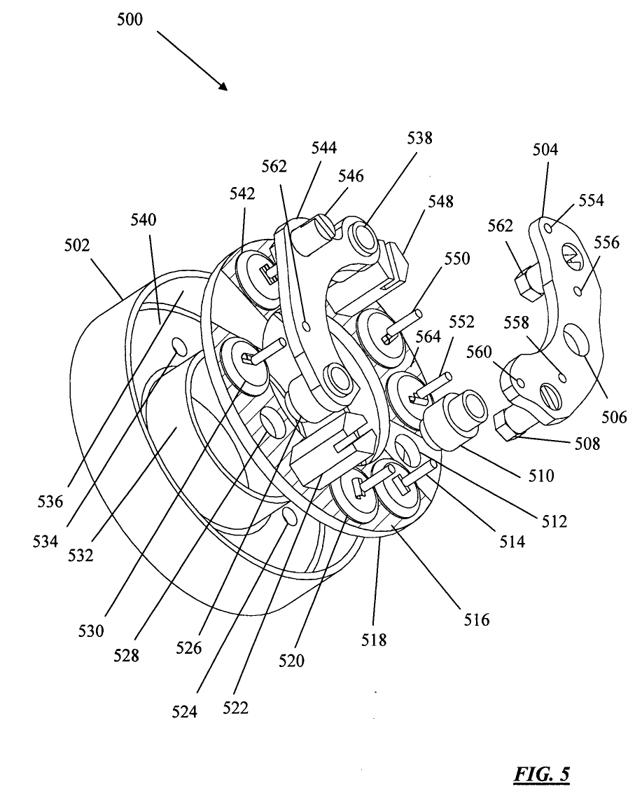

FIG. 5 depicts an exploded view of a preferred embodiment of a rotating rectifier assembly 500 which includes a metallic housing 502, composite substrate 518, and electrical components of a rectifier subassembly as discussed above in relation with FIG. 4. According to one preferred embodiment, an encapsulant (not shown for clarity) may be used to substantially fill an annular cavity 540 defined as the space between an inner surface 536 and an outer surface 532. Accordingly, the rectifier assembly 500 is a modular unit that can be easily coupled to a rotor.

According to one preferred method of assembly, the electrical components are assembled atop the composite substrate 518. Three standard polarity diodes 514, 520, and 530, three reverse polarity diodes 542, 550, and 552, and terminals 522 and 548 are all positioned on metallic components 516 and 564. Said diodes and terminals are then coupled with the metallic components using brazing or high temperature soldering. Three electrically insulating fasteners 510, 526, and 538 are also coupled with the composite substrate 518 via three holes 512, 528, and a third one that is not visible due to the angle of view. Two PC boards 504 and 544 are subsequently coupled with the diodes 514, 520, 530, 542, 550, and 552, via soldering.

As discussed above in relation with FIG. 3, an adhesive is applied to the bottom side of the composite substrate 518 and the assembly is placed within the annular cavity 540 in contact with the metallic housing 502, while ensuring that the holes of the composite substrate 518 are aligned with the holes of the metallic housing 502, i.e., holes 524, 534, and a third one that is not visible due to the angle of view. The holes are then masked and an encapsulant, such as an epoxy, is poured into the annular cavity 540. The epoxy protects the electrical components from environmental factors that could damage the components, including dust, humidity, and moisture. As a polymer, the epoxy also softens shock and vibration that could induce or accelerate fatigue failure of the rotating rectifier assembly.

The foregoing discloses a rotating rectifier assembly that may be used in combination with a high power density generator in a vehicle electrical system. The rotating rectifier assembly comprises a metallic housing, a composite substrate, and a rectifier subassembly which are placed within an annular cavity inside the metallic housing. The rectifier subassembly operates to rectify a polyphase AC current and to output a high DC current that may feed the generator's main rotor. In applications where excessive heat and/or shock and vibration are present, an encapsulant may be used to fill the annular cavity.

The foregoing explanations, descriptions, illustrations, examples, and discussions have been set forth to assist the reader with understanding this invention and further to demonstrate the utility and novelty of it and are by no means restrictive of the scope of the invention. It is the following claims, including all equivalents, which are intended to define the scope of this invention.

What is claimed is:

1. A rotating rectifier assembly, comprising:
(a) a substantially circular metallic housing comprising an annular cavity;
(b) a substantially circular composite substrate disposed within the cavity;
(c) a rectifier subassembly coupled with the substrate; and
(d) an encapsulant that substantially fills the cavity.

2. The rotating rectifier assembly of claim 1, wherein the housing further comprises a bore operative to receive a rotor according to a fastening fit, wherein the rotating rectifier assembly is coupled to the rotor via the fastening fit.

3. The rotating rectifier assembly of claim 2, wherein the fastening fit comprises at least one of an interference fit and shrink fit.

4. The rotating rectifier assembly of claim 1, wherein the housing further comprises one or more holes operative to receive one or more fasteners.

5. The rotating rectifier assembly of claim 4, wherein the substrate is coupled to the housing via the one or more fasteners.

6. The rotating rectifier assembly of claim 4, wherein the housing is coupled to a rotor via the one or more fasteners.

7. The rotating rectifier assembly of claim 4, wherein the one or more fasteners comprise an electrically insulating material.

8. The rotating rectifier assembly of claim 1, wherein the substrate is coupled to the housing via an adhesive.

9. The rotating rectifier assembly of claim 1, wherein the substrate comprises a ceramic component and a metallic component.

10. The rotating rectifier assembly of claim 9, wherein the metallic component is fused onto the ceramic component via a metallization process.

11. The rotating rectifier assembly of claim 9, wherein the metallic component comprises two metallic regions.

12. The rotating rectifier assembly of claim 1, wherein the substrate is a substantially half circle.

13. The rotating rectifier assembly of claim 1, wherein the rectifier subassembly comprises one or more rectifying diodes.

14. The rotating rectifier assembly of claim 13, wherein the one or more rectifying diodes comprise at least one of a standard polarity diode and reverse polarity diode.

15. The rotating rectifier assembly of claim 1, wherein the rectifier subassembly comprises one or more printed circuit boards.

16. The rotating rectifier assembly of claim 1, wherein the rectifier subassembly comprises two terminals capable of providing rectified electrical current.

17. The rotating rectifier of claim 1, wherein the encapsulant is an epoxy.

18. A rotating rectifier assembly, comprising:
(a) a substantially circular metallic housing comprising an annular cavity;
(b) a substantially circular metallized ceramic substrate disposed within the cavity;
(c) a rectifier subassembly coupled with the substrate.

19. The rotating rectifier assembly of claim 18, further comprising:
(d) an encapsulant that substantially fills the cavity.

20. A method for providing rectified electrical current via a rotating rectifier assembly, comprising:
(a) providing a substantially circular metallic housing comprising an annular cavity;
(b) disposing a substantially circular composite substrate within the cavity;
(c) rectifying an AC current via a rectifier subassembly coupled with the substrate; and
(d) substantially filling the cavity by an encapsulant.
